(19) United States
(12) Patent Application Publication
(10) Pub. No.: US 2003/0217803 A1
(43) Pub. Date: Nov. 27, 2003

(54) Method for production of absorbent articles having the shape of pants

(76) Inventors: Kent Hermansson, Vastra Frolunda (SE); Niclas Norrby, Goteborg (SE); Catarina Linner, Lindome (SE)

Correspondence Address: BURNS, DOANE, SWECKER & MATHIS, L.L.P., P.O. Box 1404, Alexandria, VA, 22313-1404, US

(21) Appl. No.: 10/367,925

(22) Filed: Feb. 19, 2003

Related U.S. Application Data
(60) Provisional application No. 60/357,104, filed on Feb. 19, 2002.

(51) Int. Cl. B32B 31/00

(52) U.S. Cl. 156/204; 156/226; 156/269; 156/302

(57) ABSTRACT

A method for production of absorbent articles having the shape of pants including providing individual absorption cores, securing the absorption cores to an elastic material web which is advanced continuously in a direction of travel, assembling the individual articles to form a pants shape, cutting out individual articles each comprising an absorption core and a piece of the elastic material web, the cutting-out stage and assembling stage giving each article two leg openings and a waist opening. The elastic material web has an elastic extensibility in the direction of travel of at least 80%, and preferably at least 100%, and the elastic material web during production is stretched a maximum of 5% in the direction of travel of the material web.

### CROSS-REFERENCE TO RELATED APPLICATIONS

The present application claims the benefit of U.S. Provisional Application No. 60/357,104, filed in the United States on Feb. 19, 2002, the entire contents of which are hereby incorporated herein by reference.

### TECHNICAL FIELD

The invention relates to a method for production of absorbent articles having the shape of pants.

### BACKGROUND

In the production of disposable absorbent articles, such as absorbent pants, it is desired to minimize costs. A disposable article is understood as meaning an article which is intended to be discarded after use and which is not washed or otherwise restored for absorption purposes. It is therefore preferred that absorbent articles of this type can be produced as easily and as efficiently as possible, with the least possible material wastage and at the greatest possible production speed, so that the production cost and subsequently the sale price can be kept low.

A main component in absorbent pants is usually an absorption body which is arranged between two cover sheets, one of which is a liquid barrier sheet, for example, a plastic film, and the other a liquid-permeable cover sheet, for example, a nonwoven sheet. Further components, such as inner barriers, for example, raised edge barriers, arranged in connection with the liquid-permeable cover sheet, or textile-like outer covers arranged outside the liquid barrier sheet can also be present. The absorbent pants are designed with a front portion which, during use, is directed forwards on the user and lies across the latter's groin area, a rear portion which, during use, is directed rearwards on the user and lies across the latter's buttocks, and a crotch portion which is arranged between the front portion and the rear portion and is intended to be positioned at the user's crotch. The front portion, the rear portion and the crotch portion together form absorbent pants with two leg openings and a waist opening. The absorption body is usually arranged substantially centrally between the leg openings and extends at least over the crotch portion. The portions of the absorbent diapers which, during use, are arranged across the user's hips are generally free from absorption material. These portions can include, for example, parts of one or both of the cover sheets, of a separate outer cover, or of separate material pieces usually called side panels.

In order to fit the absorbent pants on a user's body shape and body size like an article of clothing, and in order to form closure seals preventing leakage around the leg openings and the waist openings, the absorbent pants are generally also provided with elastic members in the form of elastic threads or bands. The elastic threads and bands are generally secured, in a continuous process and in the stretched state, to one or more components of the absorbent pants, generally to at least one cover sheet. By means of securing stretched elastic members, for example, to a cover sheet, it is possible also to give a nonelastic material sheet elastic properties. The elastic members are kept stretched during production of the known absorbent pants. When the individual absorbent pants are cut out from a continuous production web, the stretching of the elastic members ceases and they are able to gather together into their unstretched state. In doing so, the components secured to the elastic members are also gathered together. This means that the finished absorbent pants have a creased appearance, at least in the areas around the elastic members.

Securing elastic members to a running material web in a continuous production process is relatively complicated. The elastic members are generally secured with adhesive, for example hot-melt adhesive, or setting adhesive. To ensure that the elastic members do not come loose from the material web, it is preferable, during the process, to keep the elastic members bearing against the material web until the adhesive has set, dried or hardened. This is something which complicates the production process and adversely affects the production speed. Problems can also arise in synchronizing the tensioning of the different elastic members and in achieving uniform tensioning of the elastic members independently of the speed of the running material web. A further difficulty is that of handling the finished articles when they have been cut loose from the running material web, since the articles assume an irregular three-dimensional shape as soon as the tensioning of the elastic members ceases. Folding and packaging of the finished articles have additionally proven to be very difficult stages because of their creased and three-dimensional shape.

In order to achieve a good fit of known absorbent pants and to allow the absorbent pants to be used by persons with different body shapes and body sizes, the absorbent pants are often provided with a large number of elastic members which run parallel across the front and rear portions of the absorbent pants. Although such an arrangement functions fairly well from a technical point of view, the many elastic members give the known absorbent pants a particularly creased appearance. This is a negative factor for various reasons. The greatest disadvantage is that it is difficult to conceal absorbent pants of this kind under normal clothes, which can be very embarrassing, especially for adult users of absorbent pants. The creased appearance also strengthens the immediate impression that the absorbent article is in fact a diaper, which is perceived as a negative factor by adult incontinence sufferers. It is therefore desirable to produce absorbent pants which are perceived more as underpants than as a diaper. Another disadvantage of using the creased absorbent pants is that folds and creases can cause discomfort in the form of chafing and irritation of the user's skin.

A previously known way of achieving an improved fit and of avoiding the use of a large number of stretched elastic members is to make the side panels of absorbent pants from elastic material, for example elastic nonwoven, or elastic laminate. However, the main problem of the absorbent pants with elastic side panels which have hitherto been proposed is that they are complicated to produce because they necessitate the handling of separate elastic material pieces at high production speeds. Moreover, with elastic side panels, it is possible only to obtain limited size fit and shape fit of the absorbent pants because large parts of the front portion and rear portion of the absorbent pants remain nonelastic.

### SUMMARY

A method for producing absorbent pants has been obtained which substantially eliminates the problems of previously known production methods of this kind.

The production method according to an embodiment of the invention is mainly distinguished by using an elastic material web with an elastic extensibility in the direction of travel of at least 80%, and preferably at least 100%, and the elastic material web during production is stretched a maximum of 5% in the direction of travel of the material web.

Elastic extensibility here refers to the lengthening in the direction of extension which the material permits without plastically deforming or bursting. If a material is to be considered as being elastically extensible, it is also necessary for the material, when extension ceases, to gather together and seek to recover its original extent in the direction of extension. A fully elastic material returns completely to the unextended state, while a less elastic material remains slightly stretched even when the stretching force ceases. It is expedient that the elastic material web can return to an extent which is at most 150% of the unstretched material web and preferably at most 120% thereof.

Since the production takes place with the elastic material web in a substantially unstretched state, it is possible to produce more absorbent articles per unit of time than has previously been possible. This is because each article takes up a smaller part of the length of the material web than is the case when the material web comprises a large amount of surplus material which is to be creased together to achieve an elastic effect.

Because the material web is in a substantially unstretched state, means that the tension in the material web is only so high that the material web is held bearing against rollers and other parts of the production equipment, which is necessary to guide and control the advance of the material web. The material web is preferably stretched a maximum of 3% in the direction of travel of the material web during production.

According to one embodiment of the invention, the absorption core is enclosed between a liquid-permeable cover sheet and a liquid-tight cover sheet, after which the absorption core is secured with the liquid-tight cover sheet towards the elastic material web. Thus, according to this embodiment, a core pack is produced which is secured on an elastic outer cover which, after cutting and assembling, forms elastic outer pants supporting the core pack. For reasons of comfort, it is expedient that such outer pants have a textile or textile-like character, i.e. are formed of fibre material, or of material with fibre character. The elastic material web is advantageously an elastic nonwoven.

According to another embodiment of the invention, the elastic material web is an elastic plastic film, and a liquid-permeable material layer is arranged over the second surface of the absorption cores directed away from the plastic film. The production method according to this embodiment results in an absorbent article in which the article's liquid-blocking cover sheet constitutes the main component of the parts giving the article shape. The articles can also be provided with an elastic liquid-permeable material layer. The liquid-permeable material layer can be arranged over the absorption cores in the form of a running material web. In such an embodiment, both the cover sheets can be used to form elastic pants supporting the absorption core.

According to a further embodiment of the invention, the absorption core is provided with a liquid-tight cover sheet over the second surface, i.e. the surface which in the finished absorbent pants is intended to be directed away from a user of the absorbent pants. In this case, the elastic material web consists of a liquid-permeable material which is secured to the first surface of the absorption core, being the surface which in the finished absorbent pants is intended to be directed towards a user and which will receive the body fluid emptied into the absorbent pants. Such a production process results in an absorbent article in which the absorption core is arranged on the outside of elastic pants.

According to yet another embodiment of the invention, elongate elastic members in the form of bands or threads with a principal direction of extension are secured to the elastic material web before the cutting-out stage. The elastic members can in this case be secured, for example by gluing or by ultrasound welding, to the elastic material web in such a way that, after cutting-out and assembling of the material web, they are arranged along the leg openings of the absorbent articles. Thus, the absorbent articles can in this way be provided with leg elastic. Correspondingly, the elastic members can be secured to the elastic material web in such a way that, after cutting-out and assembling of the material web, they are arranged along the waist opening of the absorbent articles. Such an arrangement of course results in the articles being equipped with waist elastic. Since it is desirable to minimize the degree of creasing-together of the absorbent articles after the cutting-out stage, it is expedient if the elastic members during the production process are stretched a maximum of 10% and preferably a maximum of 5% in the direction of extension of the elastic members. In order to achieve good sealing around the waist opening and around the leg openings of the finished articles, it is generally expedient if the stretching of the elastic members during production is greater than the stretching of the elastic material web. On application of elastic members with low prestressing, or no prestressing, it is preferred that the elastic members are secured in such a way that the elasticity in the elastic members is not inhibited. This can be done, for example, by using an elastic adhesive, by gluing in a stretchable pattern along the elastic members, or by intermittent welding. Examples of stretchable adhesive patterns are spot gluing, spray gluing, and adhesive applied in the form of adhesive strands arranged across the elastic members.

The ratio between the extensibility of the elastic members and those parts of the finished article which are formed by the elastic material web can also be controlled by choosing a less extensible material for the elastic members than for the elastic material web. Thus, the extensibility of the elastic members can advantageously be at least 10% lower than the extensibility of the elastic material web.

In another embodiment of the invention, a method for producing pant-shaped absorbent articles includes steps of advancing a web of elastic material in a direction of travel, securing at least one absorption core comprising absorbent material to the web of elastic material with the web of elastic material being in a substantially unstretched state, and cutting an individual absorbent article from the web of elastic material and the secured absorption core in a shape such that the individual absorbent article has two leg openings and a waist opening, the individual absorbent article having one of the absorption cores and a piece of the web of elastic material.

In another embodiment, the method includes advancing a web of elastic material in a direction of travel, providing at least one core pack having at least one absorption core arranged between a liquid barrier sheet and a liquid-permeable sheet, securing the at least one core pack to the web of elastic material with the web of elastic material being in a substantially unstretched state, and cutting an individual absorbent article from the web of elastic material and the secured core pack in a shape such that the individual absorbent article has two leg openings and a waist opening, the individual absorbent article having one of the core packs and a piece of the web of elastic material.

In another embodiment, the method includes advancing a first web of elastic material and a second web of elastic material in a direction of travel, securing elongated elastic members between the first web and the second web, with the first web and the second web being in substantially unstretched states, securing at least one absorption core having absorbent material to the second web with the first web and the second web being substantially unstretched, and cutting an individual absorbent article from the secured first web and second web and the secured absorption core in a shape such that the individual absorbent article has two leg openings and a waist opening, the individual absorbent article having one of the absorption cores and a piece of the first web and the second web.

In another embodiment, the method includes, advancing a first web of elastic material and a second web of elastic material in a direction of travel, securing elongated elastic members between the first web and the second web, with the first web and the second web being in substantially unstretched states, securing at least core pack comprising an absorption core disposed between a liquid barrier sheet and a liquid-permeable sheet to the second web with the first web and the second web being substantially unstretched, and cutting an individual absorbent article from the secured first web and second web and the secured core pack in a shape such that the individual absorbent article has two leg openings and a waist opening, the individual absorbent article having one of the core packs and a piece of the first web and the second web.

### BRIEF DESCRIPTION OF THE FIGURES

Embodiments of the invention will be described in greater detail below with reference to the figures in the attached drawings, in which:

FIG. 1 shows the production of absorbent pants according to a first embodiment of the invention and comprising a core pack,

FIG. 2 shows the core pack in FIG. 1,

FIG. 3 shows absorbent pants produced according to the method shown in FIG. 1,

FIG. 4 shows the production of absorbent pants according to a second embodiment of the invention,

FIG. 5 shows absorbent pants produced according to the method shown in FIG. 3,

FIG. 6 shows the production of absorbent pants according to a third embodiment of the invention, and

FIG. 7 shows absorbent pants produced according to the method shown in FIG. 6.

### DESCRIPTION OF EMBODIMENTS

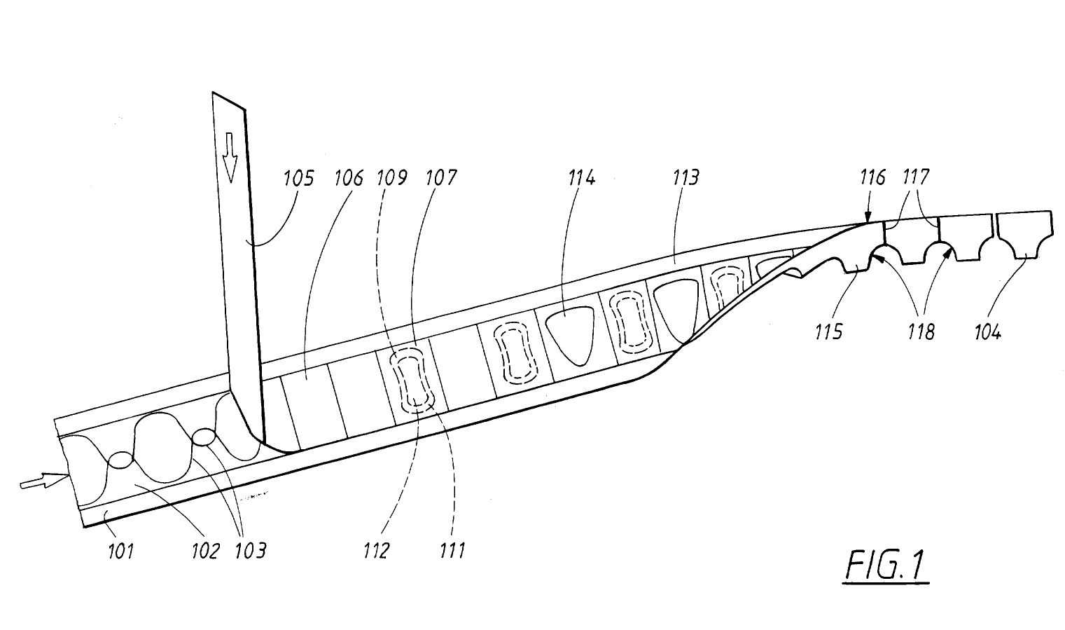

FIG. 1 is a diagrammatic representation of a process for production of absorbent pants in which the materials of the pants are substantially unstretched during production.

The various components of the absorbent pants are joined together on a continuous conveyor belt, a first material web 101 in the form of an elastic, unstretched nonwoven material being placed on the conveyor belt. Adhesive 102 is then applied, for example by spraying or coating of the first material web 101, after which elastic members 103 in the form of continuous elastic bands or threads are secured in a curved pattern across the first material web 101. The elastic members 103 form leg elastic in the finished absorbent pants. Instead of, or as a complement to, arranging adhesive on the first material web 101, the adhesive can be applied directly to the elastic members. This form of adhesive application too can be effected, for example, by means of spraying, patterned surfacing or coating. As has already been discussed, for complete coating of elastic members which have been applied in a substantially unstretched state the adhesive used should be elastic.

A second elastic material web 105, which can be substantially unstretched elastic nonwoven, is thereafter applied over the first material web 101 and the elastic members 103. Before the two material webs are joined together, the second material web 105 too can be coated with adhesive on the surface directed towards the first material web 101. Adhesive can be thereafter applied, for example in the form of a spray coating, a complete or broken film, or in a pattern such as in the form of stripes or spots. Since the elastic members, as has previously been described, are arranged substantially without prestressing, it is preferable to ensure that the adhesive does not inhibit the elasticity of the elastic members on that surface of the second material web 105 directed away from the first material web 101. The adhesive can be applied intermittently within areas 106 of the second material web 105 where a core pack 107 is then secured.

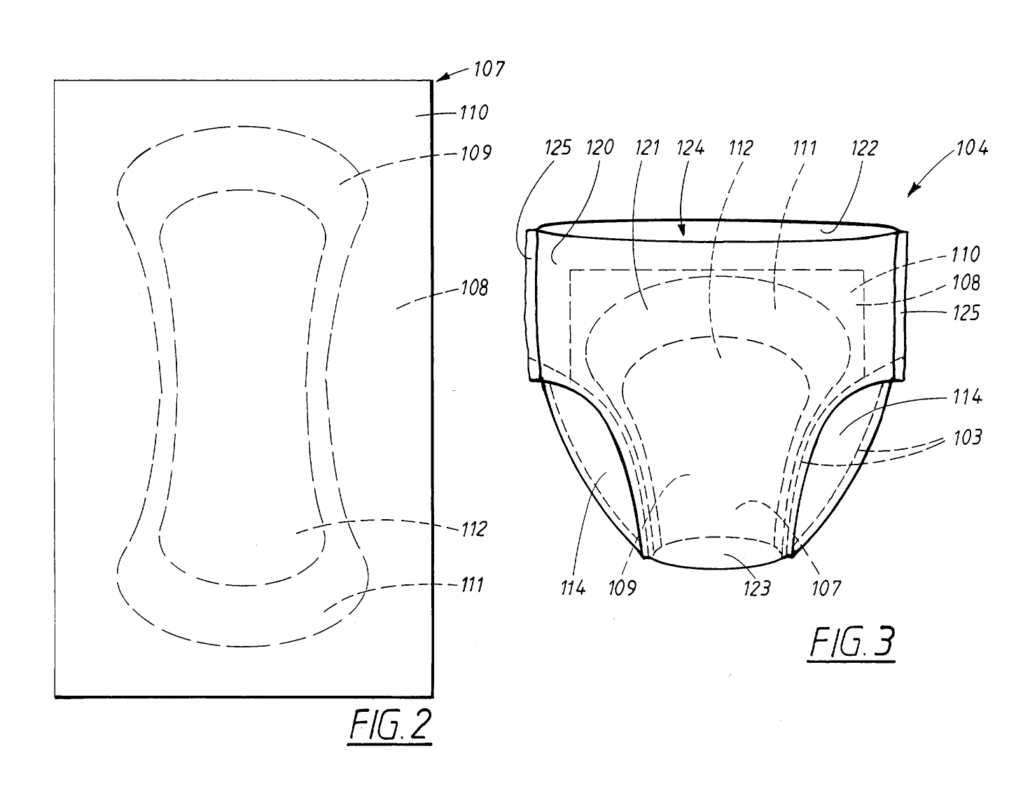

The core pack 107 is shown in FIG. 2 and comprises a liquid barrier sheet 108, an absorption core 109, and a liquid-permeable inner sheet 110. The core pack 107 is secured with the liquid barrier sheet 108 towards the second material web 105. FIGS. 1 and 2 show an absorption core 109 consisting of two absorption sheets 111, 112 laid one upon the other, the lower absorption sheet 111 located nearest to the liquid barrier sheet 108 being slightly larger than the upper absorption sheet 112 located nearest to the inner sheet 110. In the example shown, the core pack 107 has a rectangular plane shape which is defined by the shape of the liquid barrier sheet 108 and the liquid-permeable inner sheet 110, which together enclose the absorption core 109. It is of course possible to use the core pack 107 with another plane shape, for example the liquid barrier sheet 108 and the inner sheet 110 can have substantially the same shape as the absorption core 109.

The liquid-permeable inner sheet 110 can be any material known for the purpose, such as a layer of nonwoven material, a perforated plastic film, net material, tow, or the like. The inner sheet 110 can of course also be a laminate of two or more sheets of the same or different material.

The liquid barrier sheet 108 can include of a liquid-tight plastic film, a nonwoven sheet which has been coated with a liquid barrier material, or some other flexible material sheet which has the ability to withstand liquid penetration. However, it can be advantageous if the liquid barrier sheet 108 has a certain breathability, i.e. permits the passage of water vapour through the sheet 108.

The absorption core can be made up of absorbent material, such as cellulose fluff pulp, tissue, absorbent foam, etc. It is also possible for the absorption core to contain superabsorbents, i.e. polymer materials which are able to absorb body fluid corresponding to many times their own weight and form a hydrogel. Such superabsorbents are usually in the form of particles, but fibres, flakes, granules and films are also available. Moreover, the absorption core 109 can comprise nonabsorbent components such as stiffening elements, shaping elements, binders, etc. Various types of liquid-receiving porous structures such as fibre wads, open-cell foam or the like can also be included in the core pack 107.

The core pack 107 is produced in a separate process using conventional production technology. The production of the core pack 107 is not shown in the drawings. The various components included in the core pack 107 can be connected to one another in a conventional manner, for example by adhesive bonding, or by welding with heat or ultrasound. The core pack 107 can of course contain further components in addition to those described here, for example the core pack can comprise a liquid transport sheet, elastic members, shape-stabilizing members, shaping elements or the like. Although the absorption core has been shown with two absorption sheets 111, 112, alternative configurations can be used. For example, a single absorption sheet may be sufficient for certain applications, while other applications may require more than two absorption sheets.

After the core pack has been applied, leg openings 114 are cut out from the web between each core pack 107. The production web 113 is then folded double in the production direction so that a fold edge 115 and an open edge 116 are formed. The folded production web 113 is then welded intermittently transverse to the production direction, the welds 117 extending from the open edge 116 to the edge 118 on each of the leg openings 114. The welds are formed in a manner known in the technical field and are expediently openable. This means that the weld will break before the surrounding material when the parts which have been welded together are pulled apart. However, it is of course necessary to ensure that the welds are sufficiently strong to hold the finished absorbent pants together during use. It is of course alternatively possible, within the scope of the invention, to instead glue the production web halves together.

The welded production web 113 is then divided by being cut at each weld 117 so that individual absorbent pants 104 are separated from the production web 113. The finished absorbent pants 104 can then go through further process stages such as folding and packaging.

The finished absorbent pants 104 shown in FIG. 3 comprise elastically extensible outer pants 120 which are formed by the first elastic material web 101 and the second elastic material web 105. The outer pants 120 also include the elastic members 103 which are arranged around the leg openings 114 and are secured between the first elastic material web 101 and the second elastic material web 105. As has already been mentioned, the elastic material webs 101, 105 can be an elastic nonwoven material. The elastic nonwoven material is elastically extensible at least in the direction of travel of the production web and preferably also in the transverse direction of the production web, i.e. at right angles to the direction of travel.

The outer pants 120 are designed with a front portion 121, a rear portion 122 and a narrower crotch portion 123 lying between these, and they have two leg openings 114 and a waist opening 124. The outer pants 120 also have two side seams 125 which connect the front portion 121 to the rear portion 122 between the waist opening 124 and the leg openings 114 and which, during use of the absorbent pants 104, are intended to be arranged across the user's hips. The side seams 125 can be expediently designed in such a way that they can withstand the tensile forces which arise when the absorbent pants are being put on and are being used, but such that they can be torn apart when the absorbent pants are being taken off. An openable side seam 125 in this case does not have a greater holding ability than that the seam bursts at a lower force than is required to draw apart the surrounding material of the absorbent pants.

The above-described core pack 107 is secured inside the elastically extensible outer pants 120. In connection with the cutting-out of the leg openings, parts of the cover sheets in the core pack are also cut so that the core pack 107 in the finished absorbent pants is given a shape like an hourglass.

The core pack 107 can be secured to the outer pants 120 across the whole of the common surface, or only over parts thereof. For example, the core pack 107 can be secured only along a line or a band-shaped area extending centrally across the absorbent pants 104 from the front portion 121 to the rear portion 122. It is also possible to secure the core pack 107 via a number of attachment points or attachment areas. The core pack 107 should be sufficiently well secured inside the outer pants 120 to ensure that it does not come loose or move out of position during use. However, it is advantageous if the core pack 107 has a certain mobility in relation to the outer pants 120, since this means that the elastic extensibility of the outer pants 120 can be better used if the extension is limited as little as possible by the core pack 107.

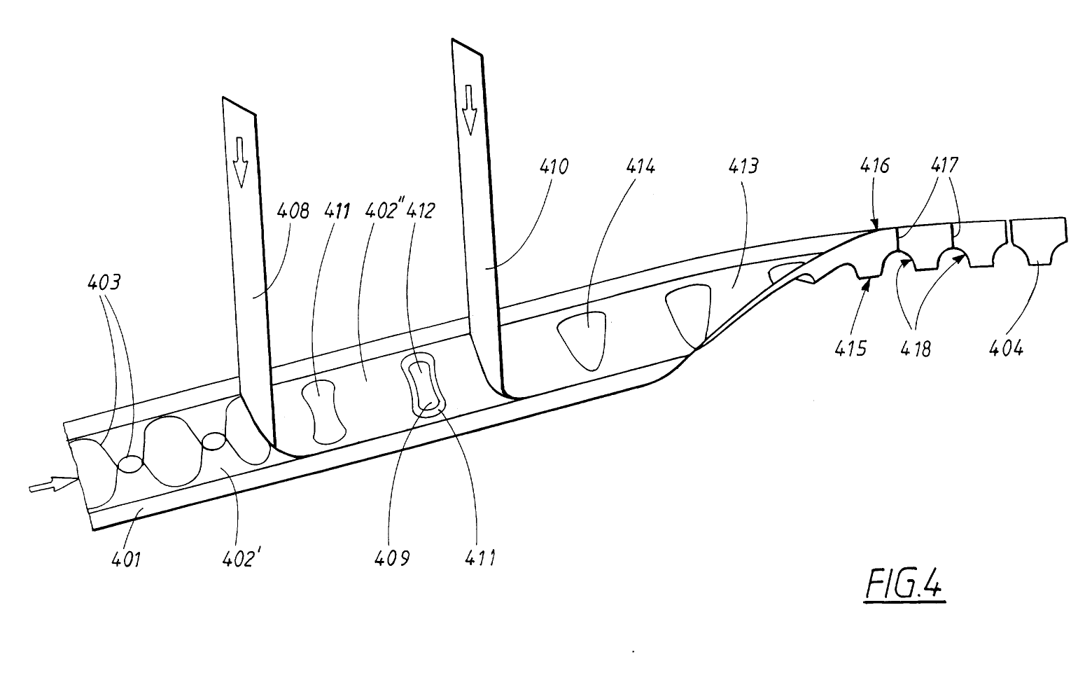

In the process shown in FIG. 4, a first elastic material web 401 in the form of a substantially unstretched elastic nonwoven material is placed on a conveyor belt (not shown in the figure). Adhesive 402′ is then applied, in the same way as in the process in FIG. 1, and elastic members 403 are secured in a curved pattern across the first material web 401.

A second elastic material web 408, of substantially unstretched elastic liquid barrier material, such as plastic film, is thereafter applied over the first elastic material web 401 and the elastic members 403. Before the two material webs are joined together, the second elastic material web 408 too can be coated with adhesive on the surface directed towards the first elastic material web 401. Adhesive is thereafter applied as a continuous coating 402″ on the surface of the second elastic material web 408 directed away from the first elastic material web 401, after which absorption cores 409 comprising a first absorption sheet 411 and a second absorption sheet 412 are placed intermittently on the second elastic material web 408.

A third elastic material web 410 is placed over the first and second elastic material webs 401, 408 and secured over the absorption cores 409. Before the third elastic material web 410 is applied on the second elastic material web 408, the third elastic material web 410 is expediently coated with adhesive on the surface directed towards the second elastic material web 408. It is alternatively possible to use a nonelastic material instead of the elastic material web 410. However, in such an embodiment, the nonelastic material can be arranged in the form of discrete pieces across the absorption cores 409. Otherwise, the nonelastic material can inhibit the function of the elastic members 403.

After the various components have been applied, leg openings 414 are cut out from the production web 413. The production web 413 is then folded double in the production direction so that a fold edge 415 and an open edge 416 are formed. The folded production web 413 is then welded intermittently transverse to the production direction, the welds 417 extending from the open edge 416 to the edge 418 on each of the leg openings 414. The welded production web 413 is then divided by being cut at each weld 417 so that individual absorbent pants 404 are separated from the production web 413. The finished absorbent pants 404 can then go through further process stages such as folding and packaging.

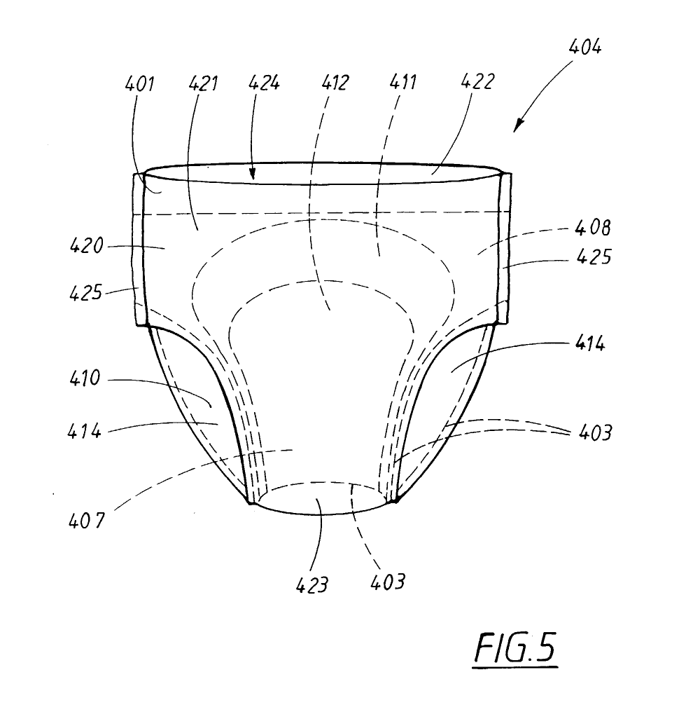

FIG. 5 shows finished absorbent pants 404 produced by the method shown in FIG. 4. The finished absorbent pants 404 shown in FIG. 5 include, like the absorbent pants in FIG. 3, elastically extensible outer pants 420 which are formed by the first elastic material web 401 and the second elastic material web 408. The first elastic material web 401 in this case constitutes a textile outer sheet of the diaper pants, and the second elastic material web 408 constitutes a liquid barrier sheet in the absorbent pants 404 and prevents liquid from leaking out from the absorbent pants 404 during use. The outer pants 420 also include the elastic members 403 which are arranged around the leg openings 414 and are secured between the textile outer sheet 401 of the outer pants 420 and the liquid barrier sheet 408. As has already been mentioned, the textile outer sheet 401 consists of elastic nonwoven material.

The liquid barrier sheet 408 consists of an elastic liquid-tight plastic film, an elastic liquid-impeding nonwoven material, or similar. A liquid-tight material is considered to be a material which prevents liquid penetration. However, the liquid-tight material can be breathable and permit passage of gases and water vapour. A liquid barrier material counteracts liquid penetration but is not necessarily completely liquid-tight and is generally breathable.

In the same way as the absorbent pants 104 shown in FIG. 3, the outer pants 420 are designed with a front portion 421, a rear portion 422 and a narrower crotch portion 423 lying between these, and they have two leg openings 414 and a waist opening 424. The outer pants 420 also have two side seams 425 which connect the front portion 421 to the rear portion 422 between the waist opening 424 and the leg openings 414 and which, during use of the absorbent pants 404, are intended to be arranged across the user's hips.

An absorption body 409 is secured inside the elastically extensible outer pants 420. The absorption body 409 is secured to the liquid barrier sheet 408 of the outer pants 420, for example by adhesive bonding. The absorption body 409 comprises a first liquid collection sheet 411 arranged nearest to the liquid barrier sheet, and a second liquid-receiving sheet 412 arranged between the liquid collection sheet 411 and a liquid-permeable inner sheet 410 which is formed by the third material web 410. Although the absorption body 409 has been shown as a two-sheet structure, it is possible to use other types of absorption bodies. Absorption bodies in absorbent articles for taking up body fluids usually consist of fibre sheets, for example of cellulose fluff pulp. It is also possible to use fibre sheets which have been bonded together with a binder, for example thermofibres. It is also customary to use polymeric gel-forming absorption materials, called superabsorbents, which can be mixed with fibres or arranged on separate carrier sheets. The design of the absorption body 409, like the choice of material, is of course dictated by the intended application and by the amount of liquid which the absorption body is expected to be able to absorb. The liquid-permeable inner sheet 410 can be a liquid-permeable nonwoven material, a perforated plastic film, a net material, or similar. The liquid-permeable inner sheet 410 can be elastic or nonelastic. In the latter case, the inner sheet 410 is arranged as discrete material pieces which do not cover the elastic members 403 arranged around the leg openings 414.

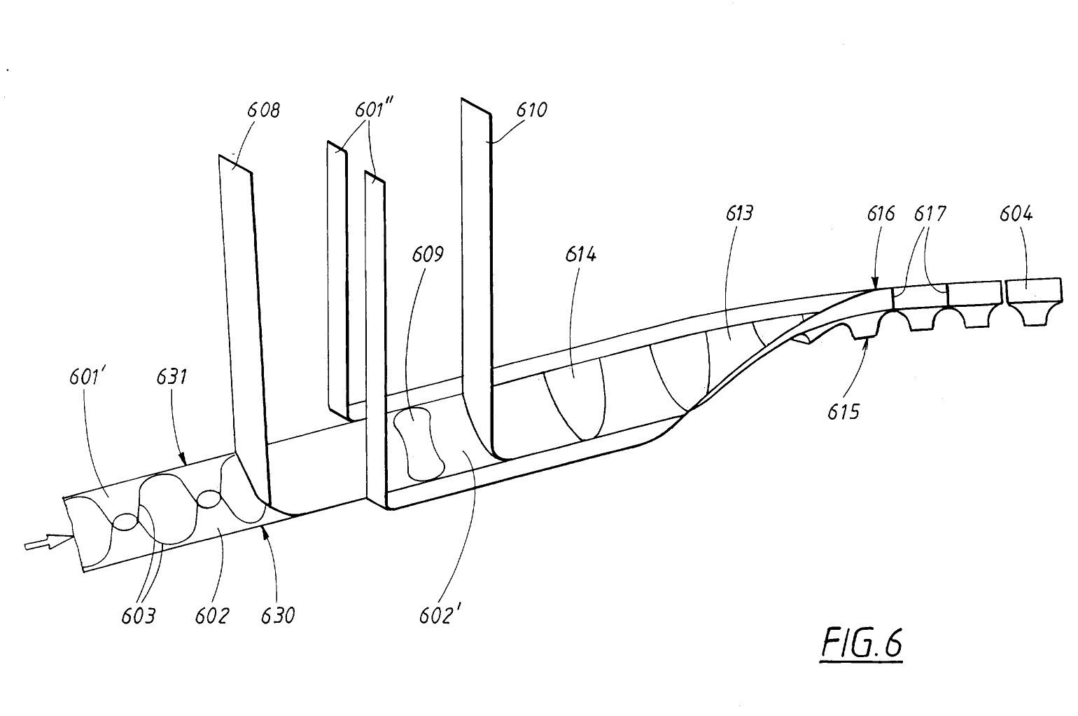

The production method shown in FIG. 6 differs from the previously described production methods in that the finished absorbent pants have, in addition to conventional leg elastic, a portion which during use is intended to surround the lower part of the user's trunk and which is elastically extensible.

The absorbent pants 604 in FIG. 6 are formed by a first material web 601′ in the form of an unstretched nonelastic nonwoven material being placed on a conveyor belt (not shown). Adhesive 602 is then applied, for example by spraying, pressing or coating of the first material web 601′, and elastic members 603 in the form of continuous elastic bands or threads are secured, in a conventional manner, in a prestressed state and in a curved pattern across the first material web 601′. A second material web 608 of liquid-tight material, for example plastic film, is secured over the first material web 601′ and the elastic members 603. Before the two material webs are joined together, the second material web 608 can also be coated with adhesive on the surface directed towards the first material web 601′. Adhesive is then applied as a coating 602′ on the surface of the second material web 608 directed away from the first material web 601′, after which absorption cores 609 are applied intermittently on the second material web 608.

A band 601″ of elastic material, for example elastic nonwoven, is additionally arranged along each side edge 630, 631 of the first material web 601′. The elastic bands 601″ are applied and secured to the first material web 601′ and the second material web 608 in a substantially unstretched state and form a band-shaped, elastically extensible portion or girdle-like waist belt nearest the waist opening of the finished absorbent pants 604. It should be noted that, in the embodiment in FIG. 6, the absorption cores 609 are secured directly to the second material web 608 and only indirectly secured to the elastic bands 601″.

A third material web 610 is placed over the first and second material webs 601, 608 and secured over the absorption cores 609. Before the third material web 610 is applied on the second material web 608, the third material web 610 is expediently coated with adhesive on the surface directed towards the second material web 608.

As in the previously described production methods, leg openings 614 are cut out from the material web 613, after which the material is folded, welded, and cut into individual absorbent pants 604, as has previously been described.

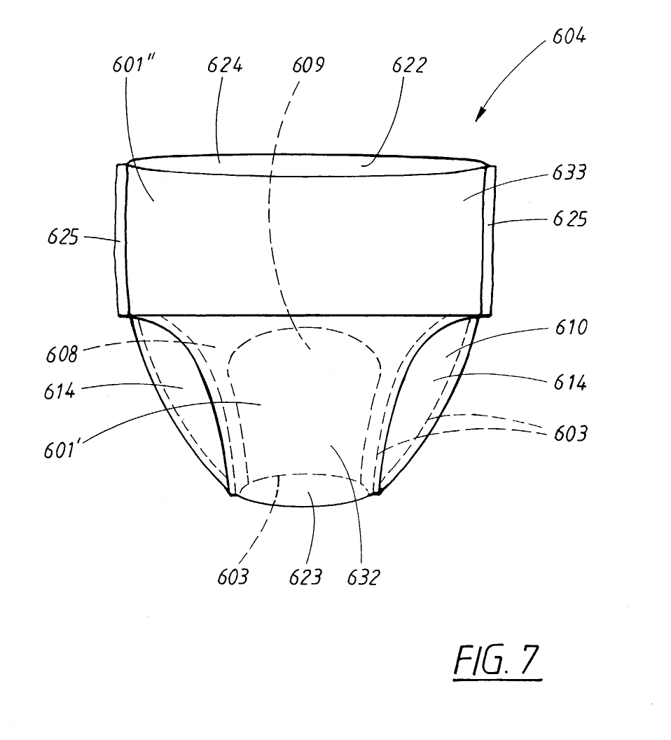

FIG. 7 shows absorbent pants 604 produced according to the method described in connection with FIG. 6. The absorbent pants shown in FIG. 7 comprise a substantially nonelastic part 632 which substantially coincides with the crotch portion 623 of the absorbent pants. The nonelastic part comprises an absorption body 609 arranged between a liquid-tight laminate and a liquid-permeable inner sheet 610. The liquid-tight laminate in this case comprises a barrier sheet 608 formed by the second material web and an outer nonwoven sheet 601′ formed by the first material web. The nonelastic part 632 comprises elastic members 603 which are secured with prestressing to the nonelastic part and which form leg elastic around the leg openings 614 of the absorbent pants 604.

The absorbent pants 604 further comprise an elastic part 633 formed by the elastic bands 601″ and constituting a wide elastically extensible belt which surrounds the trunk and which is held together by two side seams 625. The side seams 625 connect the front portion 621 of the absorbent pants to the rear portion 622 between the waist opening 624 and the leg openings 614 and are intended to be arranged across the user's hips during use.

All the absorbent pants which have been described are such that they are made from material joined together in a substantially unstretched state, i.e. with only a slight degree of elastic tensioning. As has previously been mentioned, this means that the elastic components are stretched only a maximum of 5% from their original extent in the direction of extension. A certain slight extensibility is generally necessary to maintain control of the materials during the production process. The fact that the absorbent pants are made from substantially unstretched material means that the number of absorbent pants per unit of length of the production web, compared with conventional production processes, is considerably greater and can even be as much as twice as great.

In addition, after they have been separated from the production web, the finished absorbent pants are substantially smooth and have a substantially plane shape. This means that the absorbent pants have an aesthetically pleasing appearance, are comfortable to wear, and are considerably easier to fold and package than previously known absorbent pants with creased and three-dimensionally curved portions.

The elastic parts of absorbent pants produced according to the methods described above are activated when the absorbent pants are put on. The elastic portions are stretched so that the absorbent pants can fit onto the user's body. The size of the absorbent pants is such that the elastic portions are kept stretched during use and thus seek to draw together to their unstressed state, by which means the absorbent pants are maintained on the user's body.

The invention is not to be regarded as being limited by the illustrative embodiments described above, and further variants and modifications are possible within the scope of the attached patent claims. For example, it is not necessary to join the various material webs and components together by means of adhesive, and instead other methods of joining such as ultrasound, hot welding, calendering, stitching, etc., can be used if expedient.

In the illustrative embodiments of absorbent pants which have been described, the absorption body has been shown positioned over the front portion, rear portion and crotch portion of the absorbent pants. For certain purposes, for example for use in cases of mild incontinence and menstruation, the absorption body can be placed mainly in the crotch portion of the absorbent pants, i.e. in the portion which is arranged at the user's crotch during use.

Although only preferred embodiments are specifically illustrated and described herein, it will be appreciated that many modifications and variations of the present invention are possible in light of the above teachings and within the purview of the appended claims without departing from the spirit and intended scope of the invention.

1. A method for producing pant-shaped absorbent articles, the method comprising:
advancing a web of elastic material in a direction of travel;
securing at least one absorption core comprising absorbent material to the web of elastic material with the web of elastic material being in a substantially unstretched state;
cutting an individual absorbent article from the web of elastic material and the secured absorption core in a shape such that the individual absorbent article has two leg openings and a waist opening, the individual absorbent article having one of the absorption cores and a piece of the web of elastic material.

2. A method according to claim 1, wherein the web of elastic material has an elastic extensibility in the direction of travel of at least about 80%.

3. A method according to claim 1, wherein the web of elastic material has an elastic extensibility in the direction of travel of at least about 100%.

4. A method according to claim 1, wherein the web of elastic material comprises an elastic nonwoven web.

5. A method according to claim 1, wherein the web of elastic material comprises a plastic film.

6. A method according to claim 1, further comprising:
applying an adhesive to the web of elastic material at portions of the web intended to be secured to the absorption core.

7. A method according to claim 6, wherein the step of securing the at least one absorption core comprises:
applying the at least one absorbent core over the adhesive on the web of elastic material.

8. A method according to claim 1, further comprising:
folding the web of elastic material and the secured absorption core along a fold line in the direction of travel to form a folded production web having a folded edge and an open edge.

9. A method according to claim 8, further comprising:
welding or adhering the folded production web along weld lines extending from the folded edge to the open edge to form a waist opening for each absorbent article.

10. A method according to claim 1, further comprising:
applying a layer of elastic material in the form of a running web over the at least one absorbent core on a side of the absorbent core facing away from the web of elastic material.

11. A method according to claim 10, wherein the layer of elastic material is liquid-permeable and the web of elastic material is liquid-impermeable.

12. A method according to claim 1, further comprising:
applying a piece of non-elastic material over each absorbent core on a side of the absorbent core facing away from the web of elastic material.

13. A method according to claim 12, wherein the piece of non-elastic material is liquid-permeable and the web of elastic material is liquid-impermeable.

14. A method according to claim 1, wherein the web of elastic material is liquid-permeable.

15. A method according to claim 1, wherein the web of elastic material is liquid-impermeable.

16. A method according to claim 1, wherein the absorbent core includes at least one of at least one of cellular fluff, pulp, absorbent foam, or superabsorbents.

17. A method according to claim 1, wherein the absorbent core comprises at least one sheet of absorbent material.

18. A method according to claim 1, wherein the web of elastic material is stretched no more than about 5% in the direction of travel during said advancing, said securing, and said cutting.

19. A method according to claim 1, wherein the web of elastic material is stretched no more than about 5% in the direction of travel during production of the absorbent pants.

20. A method for producing pant-shaped absorbent articles, the method comprising:
advancing a web of elastic material in a direction of travel;
providing at least one core pack having at least one absorption core arranged between a liquid barrier sheet and a liquid-permeable sheet;
securing the at least one core pack to the web of elastic material with the web of elastic material being in a substantially unstretched state;
cutting an individual absorbent article from the web of elastic material and the secured core pack in a shape such that the individual absorbent article has two leg openings and a waist opening, the individual absorbent article having one of the core packs and a piece of the web of elastic material.

21. A method according to claim 20, wherein the web of elastic material has an elastic extensibility in the direction of travel of at least about 80%.

22. A method according to claim 20, wherein the web of elastic material has an elastic extensibility in the direction of travel of at least about 100%.

23. A method according to claim 20, wherein the web of elastic material comprises an elastic nonwoven web.

24. A method according to claim 20, wherein the web of elastic material comprises a plastic film.

25. A method according to claim 20, further comprising:
applying an adhesive to the web of elastic material at portions of the web intended to be secured to the core pack; and
applying the at least one core pack over the adhesive on the web of elastic material.

26. A method according to claim 20, further comprising:
folding the first web of elastic material and the secured core pack along a fold line in the direction of travel to form a folded production web having a folded edge and an open edge.

27. A method according to claim 26, further comprising:
welding or adhering the folded production web along weld lines extending from the folded edge to the open edge to form a waist opening for the absorbent article.

28. A method according to claim 20, further comprising:
applying a layer of elastic material in the form of a running web over the at least one core pack on a side of the absorbent core facing away from the web of elastic material.

29. A method according to claim 28, wherein the layer of elastic material is liquid-permeable and the web of elastic material is liquid-impermeable.

30. A method according to claim 20, further comprising:
applying a piece of non-elastic material over each core pack on a side of the core pack facing away from the web of elastic material.

31. A method according to claim 30, wherein the piece of non-elastic material is liquid-permeable and the web of elastic material is liquid-impermeable.

32. A method according to claim 20, wherein the web of elastic material is liquid-permeable and the core pack is arranged on the web of elastic material with the liquid barrier sheet facing away from the web of elastic material.

33. A method according to claim 20, wherein the web of elastic material is liquid-impermeable and the core pack is arranged on the web of elastic material with the liquid barrier sheet facing toward the web of elastic material.

34. A method according to claim 20, wherein the absorbent core includes at least one of cellular fluff, pulp, absorbent foam, or superabsorbents.

35. A method according to claim 20, wherein the absorbent core comprises at least one sheet of absorbent material.

36. A method according to claim 20, wherein the liquid barrier sheet is a liquid-tight plastic film or a non-woven sheet coated with a liquid barrier material.

37. A method according to claim 20, wherein the web of elastic material is stretched no more than about 5% in the direction of travel during said advancing, said securing, and said cutting.

38. A method according to claim 20, wherein the web of elastic material is stretched no more than about 5% in the direction of travel during production of the absorbent pants.

39. A method according to claim 20, wherein the liquid-permeable sheet of the core pack is a non-woven, a perforated plastic film, a net material, tow, or a laminate of at least two sheets.

40. A method according to claim 20, wherein the liquid barrier sheet allows water vapor to pass through the liquid barrier sheet.

41. A method according to claim 20, further comprising:
securing elongated elastic members to the web of elastic material.

42. A method according to claim 41, the elongated elastic members being stretched no more than about 10%.

43. A method according to claim 42, the elongated elastic members being stretched no more than about 5%.

44. A method according to claim 41, wherein the elongated elastic members have an extensibility at least 10% less than the extensibility of the web of elastic material.

45. A method according to claim 41, wherein the elongated elastic members are stretched more than the web of elastic material during said securing of the elongated elastic members to the web of elastic material.

46. A method according to claim 41, wherein the elongated elastic members are arranged to form leg elastic or waist elastic.

47. A method according to claim 41, wherein the elongated elastic members are arranged in a curving pattern on the web of elastic material.

48. A method according to claim 41, wherein the elongated elastic members are secured to the web in a manner allowing the elongated elastic members to stretch when the pant-shaped absorbent article is worn.

49. A method according to claim 41, wherein said elongated elastic members are secured with elastic adhesive, intermittent welding, or gluing in a stretchable pattern.

50. A method for producing pant-shaped absorbent articles, the method comprising:
advancing a first web of elastic material and a second web of elastic material in a direction of travel;
securing elongated elastic members between the first web and the second web, with the first web and the second web being in substantially unstretched states,
securing at least one absorption core having absorbent material to the second web with the first web and the second web being substantially unstretched;
cutting an individual absorbent article from the secured first web and second web and the secured absorption core in a shape such that the individual absorbent article has two leg openings and a waist opening, the individual absorbent article having one of the absorption cores and a piece of the first web and the second web.

51. A method according to claim 50, wherein at least one of the first web and the second web has an elastic extensibility in the direction of travel of at least about 80%.

52. A method according to claim 50, wherein both the first web and the second web have an elastic extensibility in the direction of travel of at least about 80%.

53. A method according to claim 50, wherein at least one of the first web and the second web has an elastic extensibility in the direction of travel of at least about 100%.

54. A method according to claim 50, wherein the web of elastic material comprises an elastic nonwoven web.

55. A method according to claim 50, wherein at least one of the first web and the second web of elastic comprises a plastic film.

56. A method according to claim 50, further comprising:
applying an adhesive to the second web at portions intended to be secured to the absorbent core; and
applying the absorbent core over the adhesive on the second web.

57. A method according to claim 50, further comprising:
folding the secured first and second web and the secured absorbent core along a fold line in the direction of travel to form a folded production web having a folded edge and an open edge.

58. A method according to claim 57, further comprising:
welding or adhering the folded production web along weld lines extending from the folded edge to the open edge to form a waist opening for the absorbent article.

59. A method according to claim 50, further comprising:
applying a third web of elastic material over the at least one absorbent core on a side of the absorbent core facing away from the second web of elastic material.

60. A method according to claim 50, wherein the third web is liquid-permeable and the second web of elastic material is liquid-impermeable.

61. A method according to claim 50, further comprising:
applying a piece of non-elastic material over each absorbent core on a side of the absorbent core facing away from the second web.

62. A method according to claim 61, wherein the piece of non-elastic material is liquid-permeable and the second web is liquid-impermeable.

63. A method according to claim 50, wherein the absorbent core includes at least one of cellular fluff, pulp, absorbent foam, or superabsorbents.

64. A method according to claim 50, wherein the absorbent core comprises at least one sheet of absorbent material.

65. A method according to claim 50, wherein the first web and the second web are stretched no more than about 5% in the direction of travel during said advancing, said securing, and said cutting.

66. A method according to claim 50, wherein the first web and the second web elastic material are stretched no more than about 5% in the direction of travel during production of the absorbent pants.

67. A method according to claim 50, wherein the elongated elastic members are substantially unstretched during said securing between the first and second webs.

68. A method according to claim 50, wherein the elongated elastic members are stretched no more than about 10%.

69. A method according to claim 68, wherein the elongated elastic members are stretched no more than about 5%.

70. A method according to claim 50, wherein the elongated elastic members have an extensibility at least 10% less than the extensibility of at least one of the first web or the second web.

71. A method according to claim 50, wherein the elongated elastic members are stretched more than the first web during said securing of the elongated elastic members between the first and second webs.

72. A method according to claim 50, wherein the elongated elastic members are arranged to form leg elastic or waist elastic.

73. A method according to claim 50, wherein the elongated elastic members are arranged in a curving pattern over a surface of the web of elastic material.

74. A method according to claim 50, wherein the elongated elastic members are secured between the first web and the second web in a manner allowing the elongated elastic members to stretch when the pant-shaped absorbent article is worn.

75. A method according to claim 50, wherein said elongated elastic members are secured with elastic adhesive, intermittent welding, or gluing in a stretchable pattern.

76. A method for producing pant-shaped absorbent articles, the method comprising:
advancing a first web of elastic material and a second web of elastic material in a direction of travel;
securing elongated elastic members between the first web and the second web, with the first web and the second web being in substantially unstretched states,
securing at least core pack comprising an absorption core disposed between a liquid barrier sheet and a liquid-permeable sheet to the second web with the first web and the second web being substantially unstretched;
cutting an individual absorbent article from the secured first web and second web and the secured core pack in a shape such that the individual absorbent article has two leg openings and a waist opening, the individual absorbent article having one of the core packs and a piece of the first web and the second web.

77. A method according to claim 76, wherein at least one of the first web and the second web has an elastic extensibility in the direction of travel of at least about 80%.

78. A method according to claim 76, wherein both the first web and the second web have an elastic extensibility in the direction of travel of at least about 80%.

79. A method according to claim 76, wherein at least one of the first web and the second web has an elastic extensibility in the direction of travel of at least about 100%.

80. A method according to claim 76, wherein the web of elastic material comprises an elastic non-woven web.

81. A method according to claim 76, wherein at least one of the first web and the second web of elastic comprises a plastic film.

82. A method according to claim 76, further comprising:
applying an adhesive to the second web at portions intended to be secured to the core pack; and
applying the core pack over the adhesive on the second web.

83. A method according to claim 76, further comprising:
folding the secured first and second web and the secured core pack along a fold line in the direction of travel to form a folded production web having a folded edge and an open edge.

84. A method according to claim 83, further comprising:
welding or adhering the folded production web along weld lines extending from the folded edge to the open edge to form a waist opening for the absorbent article.

85. A method according to claim 76, further comprising:
applying a third web of elastic material over the at least one core pack on a side of the absorbent core facing away from the second web of elastic material.

86. A method according to claim 76, wherein the third web is liquid-permeable and the second web of elastic material is liquid-impermeable.

87. A method according to claim 76, further comprising:
applying a piece of non-elastic material over each core pack on a side of the core pack facing away from the second web.

88. A method according to claim 87, wherein the piece of non-elastic material is liquid-permeable and the second web is liquid-impermeable, with the core pack being arranged so the liquid barrier sheet faces toward the second web.

89. A method according to claim 76, wherein the absorbent core includes at least one of cellular fluff, pulp, absorbent foam, or superabsorbents.

90. A method according to claim 76, wherein the absorbent core comprises at least one sheet of absorbent material.

91. A method according to claim 76, wherein the first web and the second web are stretched no more than about 5% in the direction of travel during said advancing, said securing, and said cutting.

92. A method according to claim 76, wherein the first web and the second web elastic material are stretched no more than about 5% in the direction of travel during production of the absorbent pants.

93. A method according to claim 76, wherein the elongated elastic members are substantially unstretched during said securing between the first and second webs.

94. A method according to claim 76, wherein the elongated elastic members are stretched no more than about 10%.

95. A method according to claim 94, wherein the elongated elastic members are stretched no more than about 5%.

96. A method according to claim 76, wherein the elongated elastic members have an extensibility at least 10% less than the extensibility of at least one of the first web or the second web.

97. A method according to claim 76, wherein the elongated elastic members are stretched more than the first web during said securing of the elongated elastic members between the first and second webs.

98. A method according to claim 76, wherein the elongated elastic members are arranged to form leg elastic or waist elastic.

99. A method according to claim 76, wherein the elongated elastic members are arranged in a curving pattern over a surface of the web of elastic material.

100. A method according to claim 76, wherein the elongated elastic members are secured between the first web and the second web in a manner allowing the elongated elastic members to stretch when the pant-shaped absorbent article is worn.

101. A method according to claim 76, wherein said elongated elastic members are secured with elastic adhesive, intermittent welding, or gluing in a stretchable pattern.

102. A method according to claim 1, wherein the web of elastic material has an elastic extensibility in the direction of travel of at least about 80%, and wherein said web of elastic is extended no more than about 5% during said advancing, said securing, and said cutting.

102. A method according to claim 20, wherein the web of elastic material has an elastic extensibility in the direction of travel of at least about 80%, and wherein said web of elastic is extended no more than about 5% during said advancing, said securing, and said cutting.

103. A method according to claim 50, wherein at least one of the first web and the second web of elastic material has an elastic extensibility in the direction of travel of at least about 80%, and wherein said one web is extended no more than about 5% during said advancing, said securing, and said cutting.

104. A method according to claim 76, wherein at least one of the first web and the second web of elastic material has an elastic extensibility in the direction of travel of at least about 80%, and wherein said one web is extended no more than about 5% during said advancing, said securing, and said cutting.
